(19) United States
(12) Patent Application Publication
(10) Pub. No.: US 2005/0109439 A1
(43) Pub. Date: May 26, 2005

(54) Integrated tire rim airbag system

(76) Inventor: David S. Droegemueller, Kersey, CO (US)

Correspondence Address: Dean P. Edmundson, P.O. Box 179, Burton, TX, 77835, US

(21) Appl. No.: 10/973,721

(22) Filed: Oct. 26, 2004

Related U.S. Application Data
(60) Provisional application No. 60/519,484, filed on Nov. 13, 2003.

(51) Int. Cl. B60C 17/02; B60C 23/00

(52) U.S. Cl. 152/519; 152/418

(57) ABSTRACT

An airbag system secured to the tire rim inside a tire. The airbag is normally in a collapsed state close to the rim. The airbag is inflated with pressurized gas in the event of a tire failure. The inflated bag generally conforms to the inner walls of the tire to support the weight of the vehicle and enable the vehicle to be safely stopped. The bag has wear surfaces composed of durable material such as nylon or Kevlar fibers.

### CROSS-REFERENCE TO RELATED APPLICATIONS

This application is based upon, and claims the benefit of, my Provisional Application No. 60/519,484, filed Nov. 13, 2003.

### FIELD OF THE INVENTION

This invention relates to vehicle tire systems. More particularly, this invention relates to safety systems in the event of a tire blowout or other catastrophic tire failure situations.

### BACKGROUND OF THE INVENTION

When vehicle tires have a blowout, or experience other types of catastrophic failure, this presents a very dangerous condition for the driver and other occupants of the vehicle. The rapid deflation of a vehicle tire can result in loss of ability of the driver to control the vehicle. Oftentimes, loss of control results in an accident with the possibility of serious injuries or death.

U.S. Pat. No. 6,601,625 (Rheinhardt) describes a vehicle wheel system which includes a high pressure reservoir (i.e. tank) on the rim. The system is designed to release air into the tire in the event that the pressure in the tire should drop below a predetermined level. The system would not, however, be able to maintain a predetermined pressure in a tire which has a blowout or other catastrophic failure because the system requires an intact tire as the final reservoir.

U.S. Pat. No. 3,196,922 (Lundberg) describes a pneumatic tire which contains a non-inflated tube. Within the tube there is an inflated rubber envelope with a weak wall portion. In the event that the tire should fail, the weak wall portion of the envelope will fail and allow air to inflate the tube. This system, however, relies on the integrity of the tire casing. If the tire casing has been destroyed, then there will only be the inflated tube to support the vehicle.

U.S. Pat. No. 3,511,294 (Bepristis et al.) describes an emergency tire inflation system which includes pressurized cylinders of fluid. The fluid is released to reinflate the tire when there is a drop in air pressure. This system would not provide the safety needed in the event a tire completely failed.

U.S. Pat. No. 5,301,729 (Blair) describes a dual chamber safety tire which includes a puncture-resistant inner tire. There is a one-way valve to enable air flow from the outer chamber to the inner chamber. The system relies upon pressure differentials between the outer tire and the inner tire. This system adds a considerable amount of weight to the wheel.

U.S. Application Publication No. 2002/0121325 (Albrecht) describes a safety liner for a vehicle tire. The liner is placed inside the tire and is said to lose air slowly when the tire loses air pressure. This system requires a compressive force to maintain the toroidal tube in its flattened form.

U.S. Pat. No. 2,560,609 (Van Hulzen) describes a tube which is built into the regular inner tube. If the outer tube loses air, the pressurized air in the innermost tube will expand to fit the interior of the outer tube. However, this is just a tube to fill the outer tube. It does not provide a wear surface for the tire.

U.S. Pat. No. 4,008,743 (Welch) describes a tire with an internal toroidal safety structure (i.e. inflatable tube or a flexible resilient foam member) which engages the wheel rim. The safety structure includes an outer belt of reinforced elastomeric material.

There has not heretofore been provided an airbag system of the type described herein for use in a tire rim.

### SUMMARY OF THE INVENTION

In accordance with the present invention there is provided an improved safety system for an inflated vehicle tire. The system includes a light-weight airbag secured to the tire rim inside the tire. In the event of rapid loss of air pressure from the tire, the airbag quickly inflates and simulates the profile of the tire with a wear surface available to support the vehicle until the driver is able to bring the vehicle under control and to a stop in a safe manner.

Other features and advantages of the system of the invention will be apparent from the following detailed description and accompanying drawings.

### BRIEF DESCRIPTION OF THE DRAWINGS

FIG. 1 is a cross-sectional view showing a wheel rim with an integrated airbag system of the invention; and

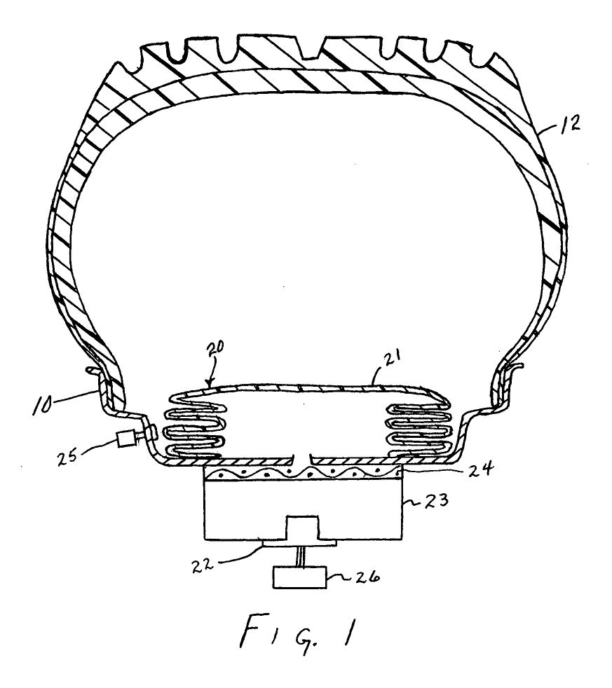

FIG. 2 is a cross-sectional view showing the airbag system after inflation.

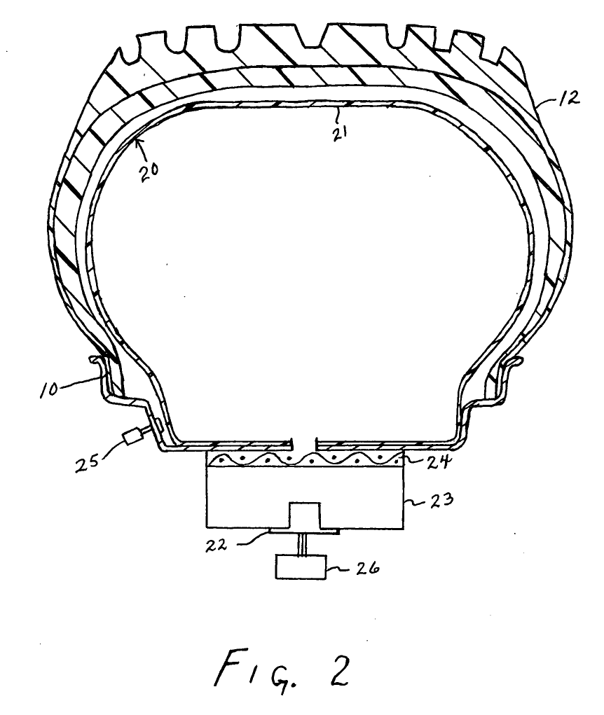

### DETAILED DESCRIPTION OF THE INVENTION

In the drawings there is shown a wheel or tire rim 10 in which the airbag system 20 is contained. The airbag has a flat, low profile and is mounted close to the wheel rim so as to provide low centrifugal force. The airbag could also be designed to have a donut shape or a flat pancake shape.

It is also possible for the airbag to include multiple cells with one-way check valves between them to maintain pressure in the majority of the cells in the event an object (such as a large spike) which might also puncture the airbag when it is deployed.

The airbag system, in one embodiment, includes the inflatable bag 21, an igniter 22, a container 23 for solid propellant (e.g. sodium azide or equivalent), a tire pressure monitoring system 25, and a controller 26. The tire pressure monitoring system 25 is attached to the wheel valve stem and it continuously monitors tire pressure. It transmits a radio frequency signal to the controller 26 when a loss of tire pressure is detected. The controller can then actuate the igniter 22 for the airbag system, either when the tire pressure below a predetermined value, or in the event of rapid depressurization of the tire. The igniter then ignites the propellant to create pressurized gas which proceeds through the filter system 24 and causes the airbag to rapidly inflate inside the tire 12.

The airbag preferably has durable wear surfaces comprising nylon or Kevlar fibers (or other such tough and durable material) integrated therein in the wear areas to provide good stability for the vehicle until deceleration is achieved. This provides rollover protection. The wear surfaces of the airbag are normally the outer surfaces adjacent to the inner wall of the tire.

The inflated profile of the airbag preferably mimics or generally conforms to the profile of the tire. All walls and wear areas of the airbag are composed of a material which can sustain inflation and wear during deceleration of the vehicle after rapid tire deflation.

The airbag system preferably includes a chemical source for rapidly producing a pressurized gas (e.g. nitrogen) to inflate the airbag when the tire rapidly loses air pressure. Alternatively, a source of highly compressed gas (e.g. air, nitrogen, or carbon dioxide) could be included to inflate the bag when the tire fails.

One type of tire pressure monitoring system which may be used in the present invention is commercially available from Fleet Specialties Company. The system includes microchip wheel sensors which attach to each valve stem to continuously monitor tire pressure and transmit a radio frequency signal when a loss of tire pressure is detected.

The controller 26 can receive the signal from the wheel sensor and actuate the igniter automatically in the event that the tire pressure rapidly lowers because of a catastrophic tire failure.

Other systems may also be used to activate a source of high pressure gas to inflate the airbag in the event of rapid decrease in tire pressure.

1. An integrated tire rim airbag system adapted to inflate rapidly in the event of tire failure and to provide a wear surface for a vehicle, thus enabling the vehicle to be decelerated and stopped safely.

2. An integrated tire rim airbag system within a tire mounted on said rim, the system comprising:
(a) inflatable bag means secured to said tire rim; wherein said bag means includes wear surfaces;
(b) means for introducing a pressurized gas into said bag means to cause said bag means to inflate in the event of rapid loss of air pressure in said tire.

3. An integrated tire rim airbag system within a tire mounted on said rim, the system comprising:
(a) inflatable bag means secured to said tire rim; wherein said bag means includes wear surfaces comprising durable fibers;
(b) pressurization means for introducing a pressurized gas into said bag means to cause said bag means to inflate in the event of rapid loss of air pressure in said tire.

4. The system of claim 3, wherein said wear surfaces comprise Kevlar fibers.

5. The system of claim 3, wherein said wear surfaces comprise nylon fibers.

6. The system of claim 3, wherein said pressurization means comprises (a) solid propellant capable of producing nitrogen gas when ignited, and (b) an igniter for igniting said propellant when air pressure in said tire is lost due to tire failure.
